(19) United States
(12) Patent Application Publication
(10) Pub. No.: US 2013/0332287 A1
(43) Pub. Date: Dec. 12, 2013

(54) METHOD FOR ACTIVE PUSH ADVERTISING

(71) Applicant: HUNT ALL CO., LTD., Taipei City (TW)

(72) Inventor: Jen-Hang Kuo, Taipei City (TW)

(73) Assignee: HUNT ALL CO., LTD., Taipei City (TW)

(21) Appl. No.: 13/658,204

(22) Filed: Oct. 23, 2012

(30) Foreign Application Priority Data
Jun. 6, 2012 (TW) 101120220

(51) Int. Cl. G06Q 30/02

(52) U.S. Cl. 705/14.68; 705/14.73

(57) ABSTRACT

The present invention provides a method for active push advertising, the method including: providing a server to which a user connects personal electronic devices; logging in the server for matching and comparing advertiser demand variables with an advertising receiving condition; sending a plurality of advertisement from the server to the personal electronic device; providing a user interface for showing an advertising prompt to inform the user of the availability of the advertisements for playing after the server confirms whether the advertising playing condition is fulfilled or not by a terminal program; providing an advertising interface which appears immediately after a point tool triggers the advertising prompt; playing the advertisement immediately after an induction condition in an induction zone of the advertising interface is triggered; and issuing virtual currency and accumulated usage value when the induction condition is continuously triggered until the end of the advertisement.

### FIELD OF THE INVENTION

The present invention provides a method for active push advertising, and particularly a method of enhancing the user's willingness and attention to receive advertising information.

### BACKGROUND OF THE INVENTION

Current delivering process of advertising information easily causes users an incongruity which may affect the efficiency of delivering of advertising information. Such incongruity may arise from different media, different strategies, different information or different groups of people. This can be explained as a disagreement with the advertising information due to personal impression of the receivers.

In addition to the incongruity as mentioned above, users became less sensitive to the advertising information because of overwhelming amounts of information in modern society. The users selectively choose the information to be received regardless of an awareness of such selectivity, which causes problems such as inattentional blindness or misled conclusion out of impatience. In other words, low willingness of receiving the advertising information and low attention in receiving the advertising information by the users affect the accuracy of overall marketing strategy for the advertiser.

To overcome the shortcomings of related arts, the present invention provides a method for active push advertising to enhance the users' willingness and attention when receiving advertising information and to achieve the goal of overall marketing strategy for the advertiser.

### SUMMARY OF THE INVENTION

One of the objectives of the present invention is to provide a method for active push advertising to enhance user's willingness and attention when receiving advertising information.

Another objective of the present invention is to provide a method for active push advertising to achieve the goal of overall marketing strategy for advertisers. In order to achieve the objective mentioned above and others, the present invention discloses a method for implementing active push advertising via internet, the method comprises following steps: providing a server to a user then can install a starting program in personal electronic devices; the starting program provides the user who can connect the server through the internet to logging in the server for matching and comparing advertiser demand variables with an advertising receiving condition; sending a plurality of advertisement to the personal electronic device; providing a user interface for showing an advertising prompt to inform the user of the availability of the advertisements for playing in an order at an initial time or after the server confirms whether the advertising playing condition is fulfilled by a terminal program or not providing an advertising interface which appears immediately after users use a point tool triggers the advertising prompt; playing the advertisement immediately after an induction condition in an induction zone of the advertising interface is triggered; playing the advertisement continuously when the induction condition in the induction zone of the advertising interface is continuously triggered; and issuing the acquiring virtual currency and accumulated usage value when the induction condition is continuously triggered until the end of the advertisement.

Compared to the related arts, the method of the present invention matches and compares a plurality of advertiser demand variables with the advertisement receiving condition set upon the user's personal preference. The user can choose to trigger the advertisement or not when the advertising prompt appears on the user interface automatically, unlike in related arts, where the user is forced to accept random advertising content.

In addition, when the user doesn't trigger the advertising prompt for a time interval, the server will once again determine which advertisement matches the advertisement receiving condition and shows the advertisement prompt again.

Furthermore, when the user stops triggering the induction condition in the induction zone of the advertising interface, the advertisement stops. The user thus cannot acquire virtual currency and accumulated usage value.

Therefore, the main objective of the method of the present invention is to enhance the user's willingness and attention to receive advertisement and to achieve the goal of overall marketing strategy. The virtual currency and its accumulated usage value is a feedback to the user after receiving advertisement, which also improves the user's motivation to browse advertisements.

### BRIEF DESCRIPTION OF THE DRAWINGS

FIG. 1 is a flow chart of a preferable embodiment of the method for active push advertising of the present invention;

FIG. 2 is a schematic diagram of a preferable embodiment of the method for active push advertising of the present invention;

Appendix 1 is a schematic diagram of the user interface of the method for active push advertising of the present invention; and

Appendix 2 is a schematic diagram of the advertising interface of the method for active push advertising of the present invention.

### DETAILED DESCRIPTION OF THE INVENTION

In order to understand the goals, characteristics, and functions of this invention, the following embodiments and examples are revealed with the reference of figures to explain the concepts of the invention specifically in detail.

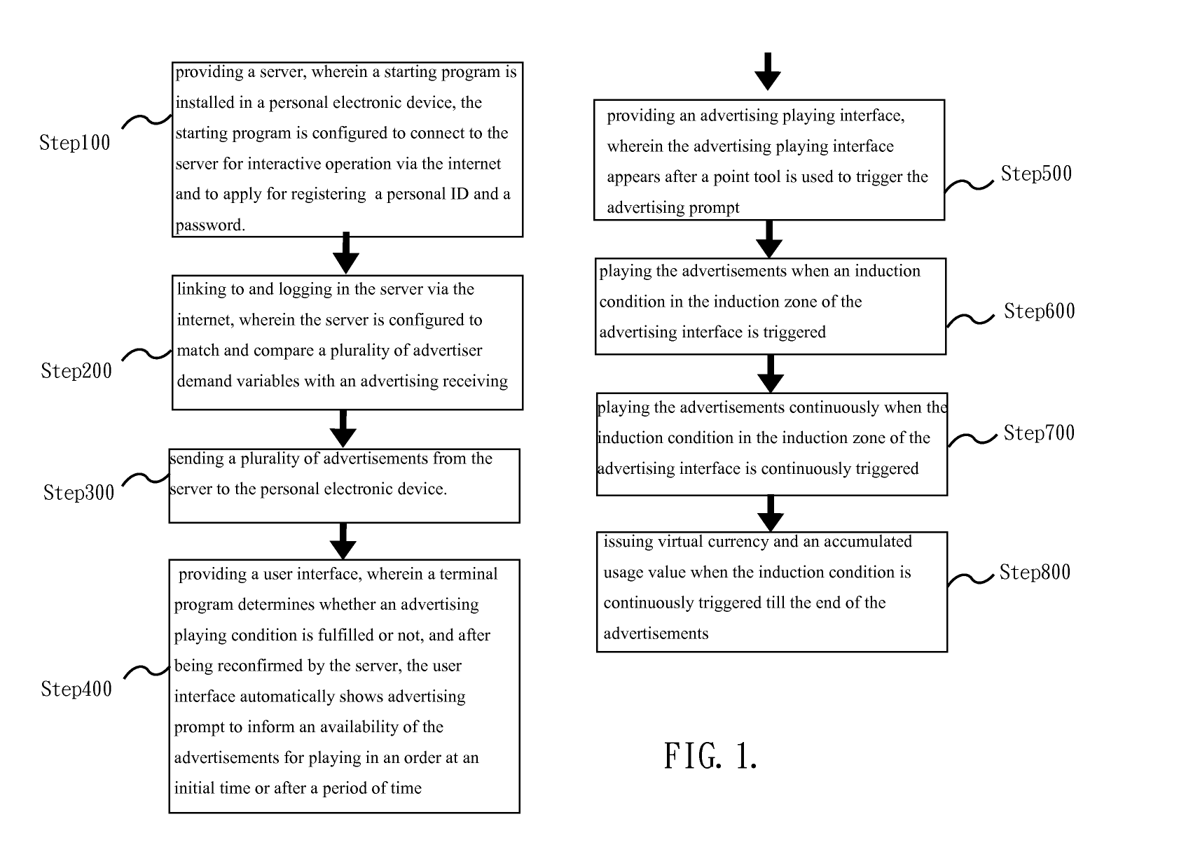

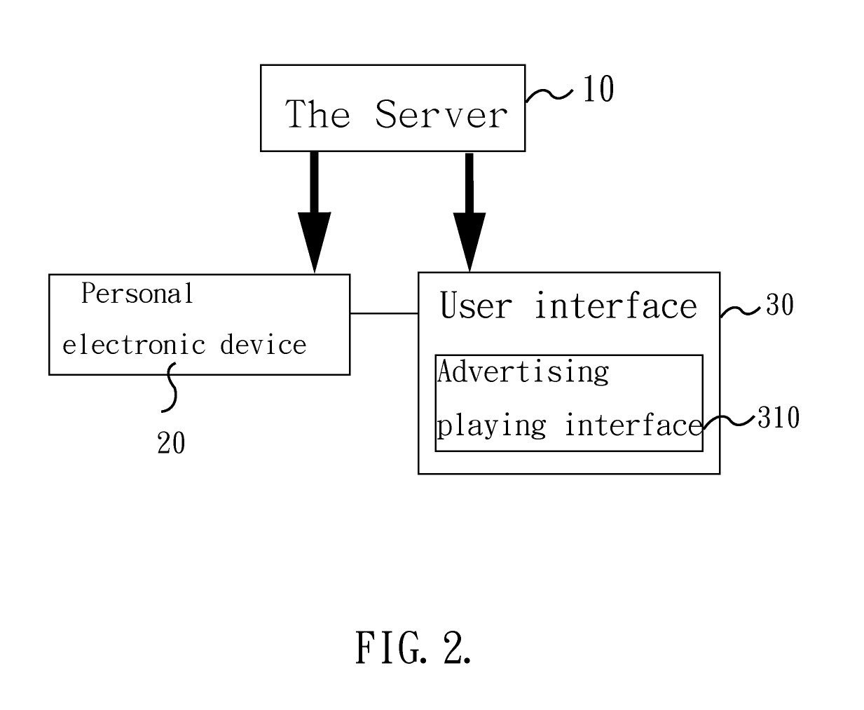

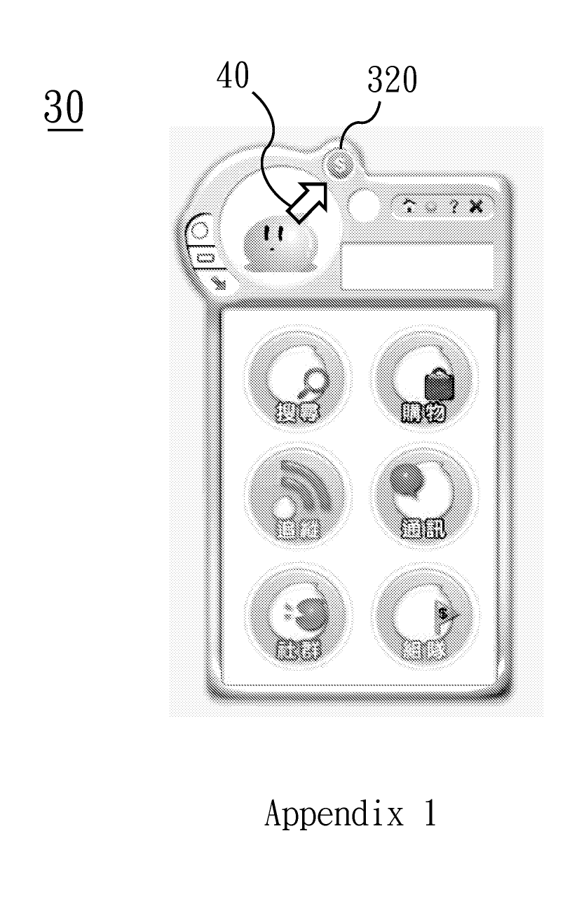

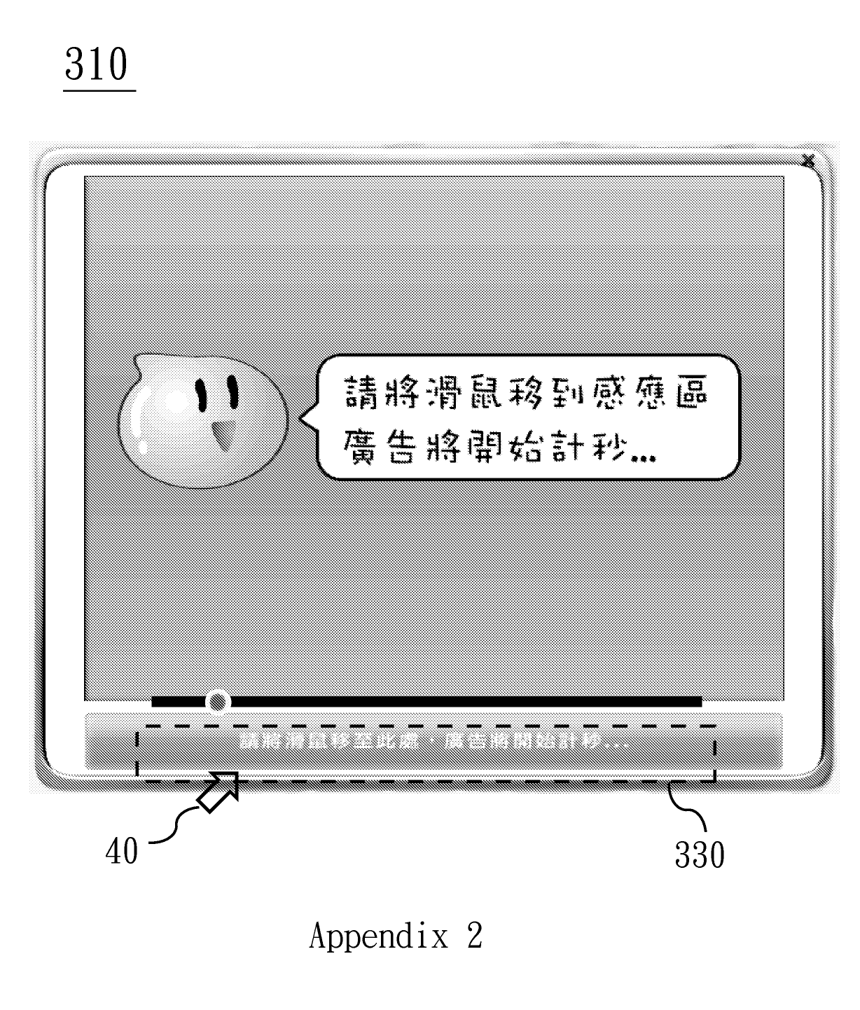

Referring to FIG. 1, FIG. 2, Appendix 1, and Appendix 2, which respectively shows a flow chart of a preferable embodiment of the method for active push advertising of the present invention, a schematic diagram of a preferable embodiment of the method for active push advertising of the present invention, a schematic diagram of the user interface of the method for active push advertising of the present invention, and a schematic diagram of the advertising interface of the method for active push advertising of the present invention. Detailed steps are presented as following. In step 100, a server is provided, wherein a starting program is installed in a personal electronic device owned by a user, which provide the user to process interactive operation with the server via the internet and to apply for registering a personal ID and a password. In step 200, the user links to and log in the server via the internet, such that the server matches and compares a plurality of advertiser demand variables with the advertisement receiving condition set by the user. In step 300, a plurality of advertisement is sent from the server to the personal electronic device. In step 400, a user interface is provided, wherein a terminal program determines whether the advertising playing condition is fulfilled or not, and after being reconfirmed by the server, automatically shows an advertising prompt to inform an availability of the advertisements for playing in an order at an initial time or after a period of time. In step 500, an advertising interface is provided, wherein the advertising playing interface immediately appears after a point tool is used to trigger the advertising prompt. In step 600, the advertisements are played immediately after the user triggers an induction condition in an induction zone of the advertising interface. In step 700, the advertisements are continuously played when the induction condition in the induction zone of the advertising interface is continuously triggered. In step 800, virtual currency and accumulated usage value is acquired to the user when the user continues to trigger the induction condition until the end of the advertisement.

The personal electronic device (20) is electrically connected with the server (10). The user interface (30) is electrically connected with the server (10) and the personal electronic device (20). The advertising interface (310) is electrically connected with the server (10). The advertising interface (310) immediately appears after the user uses the point tool (40) to trigger the advertising prompt (320).

Specifically, when the user does not trigger the advertising prompt (320) for a time interval, the terminal program will once again determine whether the advertising playing condition is fulfilled or not and reconfirm with the server (10) for showing the advertising prompt (320) again.

In addition, the advertisement stops playing when the user stops triggering the induction condition in the induction zone (330) of the advertising interface (310) so that user cannot acquire either virtual currency or the accumulated usage value. In the meanwhile, the process will be taken again by the terminal program to determine whether the advertising playing condition is fulfilled or not and reconfirmed with the server (10). Also, the advertisement's content may not be the same as the previous one which should be replayed later on. For example, the way for triggering the induction condition can be putting the point tool (40) in the induction zone (330) of the advertising interface (310) for the user.

The detailed steps are revealed as follows: the linking via the internet as described in step 100 can be performed by a wired internet connection, a wireless internet connection, or one of other linking connections. The personal electronic device (20) can be a personal computer, a notebook, a tablet, a personal digital assistant (PDA), a smart phone, an event data recorder (EDR), or a smart TV. The starting program can be obtained through a CD, a USB flash drive, or a hard disk.

The plurality of advertiser demand variables as described in step 200 can be one of the personal information such as sex, age, or interests, and information of user's behavior such as online time, or video browsing rate. The advertising receiving condition can be one of arts of life, computer games, recreational activities, food, news, vogue, and financial information which are set as favorite advertisement segment by the user.

The advertising content as described in step 300 can be a video, a picture, a text or an audio. In step 400, the user interface provides the user with interactive operation. The advertising playing condition is set by the advertiser according to the preset playing time of the advertisement, the keywords which are searched by the user on the internet or at random. For example, if the advertiser sets the advertising time as 11 o'clock every morning, the advertising prompt (320) will automatically show up at the preset timing. If the user searches keyword such as “sport,” the program of user terminal program determines that the advertising condition is fulfilled and then confirms with the server (10) to ensure the quota of advertising information is still enough. And then, show the advertising prompt (320) immediately. Specifically, the quota means the remaining amount of advertising content for playing. Besides, the advertising prompt (320) is a sign content-neutral which don't comprise any advertisements. The time interval varies from situations to be fixed or unfixed.

The point tool (40) in step 500 is a mouse cursor, an arrow, a finger, or the other tool which can be used for position.

In step 600 and step 700, the way for the user to continuously trigger the induction condition in the induction zone (330) of the advertising interface (310) can be moving left and right, moving up and down, moving diagonally, or fixing the point tool (40).

The virtual currency in step 800 can be used in e-shops for commodity exchange, discount for commodity trading, or cash exchange. The virtual currency and the accumulated usage value are fixed with the personal ID of the user, and cannot be transferred between different users. The accumulated usage value is calculated from the user's behavior data such as the login time to the server (10), the number of searches for keywords, the number of subscription of Really Simple Syndication (RSS), the number of advertisement browsing or advertisement watching completion rate. The user's level is increased when the accumulated usage value increases, so more opportunity for exposure of advertisement is obtained. The user level is decreased when the accumulated usage value decreases, so less opportunity for exposure to advertisement is obtained. For example, the level of the user means the total advertisement amount of number or time that users can watch in a fixed time. Specifically, the user's level increases continuously when the accumulated usage value increases. In contrast, the user level decreases when the accumulated usage value decreases. Furthermore, the virtual currency and the accumulated usage value can be calculated by browsing the advertisement together or logging in to the server (10) by a group or a team of multiple users. Users can form groups to recruit users from different levels, and acquire extra virtual currency and accumulated usage value through browsing the advertisement together or logging in to the server (10). The user of highest level is the leader, and the ID of the leader must be normal and cannot participate in other groups' activities. For example, there are users of different levels (level 1, level 3, and level 5) who want to form groups. The user of level 5 is the leader. The numbers of members in the group for the users are 3, 5, and 7 people respectively, which are preset by the server (10). Three situations are introduced as following; 1. If the current number of members in the group is 3, the group matches a level one user. The level one user obtains twice the feedback of virtual currency after browsing the advertisement. The other two users who don't reach the condition of the members can only obtain the preset feedback of virtual currency after the advertisement. 2. If there are 5 members in the group, the group is full for the users of level 1 and 3, who can obtain twice the feedback of virtual currency while the level five user who don't reach the condition of members can only obtain the preset feedback after browsing the advertisement. 3. If there are 7 members in the group, the group is full for each member. Each member can thus obtain twice the feedback of virtual currency after browsing the advertisement. In the meanwhile, extra bonus of virtual currency and be obtained to be delivered to each member equally.

The preferred embodiments of the present invention have been disclosed in the examples above. However the examples should not be constructed as a limitation on the actual applicable scope of the invention, and as such, all modifications and alterations without departing from the spirits of the invention and appended claims shall remain within the protected scope and claims of the invention.

What is claimed is:

1. A method for implementing active push advertising via internet, the method comprising:
providing a server, wherein a starting program is installed in a personal electronic device, the starting program is configured to connect to the server for interactive operation via the internet and to apply for registering a personal ID and a password;
linking to and logging in the server via the internet, wherein the server is configured to match and compare a plurality of advertiser demand variables with an advertising receiving condition;
sending a plurality of advertisements from the server to the personal electronic device;
providing a user interface, wherein a terminal program determines whether an advertising playing condition is fulfilled or not, and after being confirmed by the server, the user interface automatically shows an advertising prompt to inform an availability of the advertisements for playing in an order at an initial time or after a period of time;
providing an advertising playing interface, wherein the advertising playing interface appears immediately after a point tool is used to trigger the advertising prompt;
playing the advertisements when an induction condition in the induction zone of the advertising interface is triggered;
playing the advertisements continuously when the induction condition in the induction zone of the advertising interface is continuously triggered; and
acquiring virtual currency and an accumulated usage value when the induction condition is continuously triggered until the end of the advertisements.

2. The method according to claim 1, further comprising: determining again by the terminal program whether the advertising playing condition is fulfilled or not when the advertising prompt is not triggered for a time interval, and after being reconfirmed by the server, the advertising prompt is shown again.

3. The method according to claim 2, further comprising, to stop playing advertisement and acquiring the virtual currency and the accumulated usage value when the induction condition in the induction zone is not continuously triggered.

4. The method according to claim 1, wherein the linking via the internet is performed by a wired internet connection or a wireless internet connection or one of other linking connections.

5. The method according to claim 1, wherein the personal electronic device is selected from a group consisting of a personal computer, a notebook, a tablet, a personal digital assistant (PDA), a smart phone, an event data recorder (EDR), and a smart TV.

6. The method according to claim 1, wherein the starting program is obtained by a CD, a USB flash drive, or a hard disk.

7. The method according to claim 1, wherein the advertising receiving condition is selected from a group consisting of arts of life, computer games, recreational activities, food, news, vogue, and financial information, which is set as favorite advertisement segments by the user.

8. The method according to claim 1, wherein the plurality of advertiser demand variables comprises personal information of sex, age, or interests, and user behavior information of as online time, or video browsing rate.

9. The method according to claim 1, wherein the advertising playing condition is set according to a preset playing timing of the advertisement, keywords searched on the internet or at random.

10. The method according to claim 2, wherein the advertising prompt is an advertising content-neutral sign which don't comprise any advertisement.

11. The method according to claim 3, wherein the point tool is a mouse cursor, an arrow, or a finger or the other tool which can be used for position.

12. The method according to claim 3, wherein a user level is increased when the accumulated usage value increases such that more opportunity for exposure of the advertisements is obtained, and the user's level is decreased when the accumulated usage value decreases such that less opportunity for the exposure of the advertisements is obtained.
